(19) United States
(12) Patent Application Publication
(10) Pub. No.: US 2020/0078964 A1
(43) Pub. Date: Mar. 12, 2020

(54) End Effector Protection System

(71) Applicant: KUKA Systems GmbH, Augsburg (DE)

(72) Inventors: Richard Zunke, Augsburg (DE); Julian Stockschläder, Meitingen (DE); Johannes Lachner, Altomünster (DE)

(21) Appl. No.: 16/079,761

(22) PCT Filed: Feb. 24, 2017
(86) PCT No.: PCT/EP2017/054368

§ 371 Date: Apr. 17, 2019

(30) Foreign Application Priority Data
Feb. 26, 2016 (DE) 20 2016 001 261.5

(51) Int. Cl. B25J 19/00

(52) U.S. Cl. CPC B25J 19/0075

(57) ABSTRACT

An end effector protection system for at least partially enveloping an end effector of a manipulator. The system includes at least one enveloping structure which is designed to at least partially envelop the end effector of the manipulator, the enveloping structure being movably arranged in order to adjust the degree of the envelope of the end effector. In this way, the risk of injury originating from the end effector can be reduced and/or eliminated.

### CROSS-REFERENCE TO RELATED APPLICATIONS

This application is a national phase application under 35 U.S.C. § 371 of International Patent Application No. PCT/EP2017/054368, filed Feb. 24, 2017 (pending), which claims the benefit of priority to German Patent Application No. DE 20 2016 001 261.5, filed Feb. 26, 2016, the disclosures of which are incorporated by reference herein in their entirety.

### TECHNICAL FIELD

The present invention relates to an end effector protection system for enveloping an end effector of a manipulator, which end effector protection system is particularly suitable for use in human-robot collaboration.

### BACKGROUND

In addition to purely manual and purely robot-based systems, manipulators which allow human-robot collaboration (HRC) are used for a variety of work processes. This takes advantage of humans and robots working closely together to increase productivity. The human can quickly adjust to different tasks and, most importantly, unforeseeable events, while the advantages of the robot are the quick and precise execution of simple, frequently repetitive activities. HRC advantageously combines both of these strengths. Manually guided manipulators and assistance robots, among other things, are examples of such HRC systems. The former include manipulators comprising a (for example directly or by means of telemanipulation) hand-controlled manipulator arm, by means of which, for example, loads can be moved. Assistance robots are manipulators with which an operator interacts without a separating protective device.

Depending on the work process, the manipulators may guide dangerous end effectors, such as tools, for example, some of which have sharp edges or are pointed, or rotate at high velocities. This is the case in screwing stations, for example, in which manipulators with screwing tools are used. In these types of environments, the risk of injury to humans is greatly increased, even if the manipulator guiding the end effector is not moving.

The known protective measures are based on the use of a variety of sensors. Sensors can be used, for example, to locate a human in the vicinity of a manipulator. Ultrasonic sensors, for example, can be used for this purpose. Alternatively, capacitive distance sensors can be used to detect the presence of a human. A variety of responses to the detection of a human in the vicinity of the manipulator are possible. For example, the operating velocity of the manipulator can be reduced to give the human the opportunity to react to the movements of the manipulator.

The known protective measures have disadvantages, however. The sharp-edged or pointed tool in systems that use ultrasonic sensors or capacitive sensors, for example, is freely accessible. An operator can consequently be injured by the tool when the manipulator is switched off or stationary. Insofar as the reduction in the operating velocity reduces productivity, the reaction strategies are disadvantageous as well. There are also no really safe sensors currently available on the market, and sensors do not provide a sufficient ability to distinguish between a component/vicinity and a body part either. Additional sensors are also expensive.

Mechanical protective structures that shield the end effector are known as well. Furthermore, mechanical protective structures are known which shield the end effector. These mechanical protective structures are typically spring-mounted or unmounted sheaths; they can be displaced by applying a sufficiently high counterforce and expose the end effector. This counterforce can also be applied in the event of an unwanted collision of the manipulator or manually by a human, for example, so that only limited protection is provided.

The goal of the present invention is therefore to provide an improved end effector protection system, with which in particular end effectors of manipulators, such as articulated robots, can be secured in order to reduce the risk of accident and injury, for example, in HRC systems. Furthermore, it is an object of the present invention to provide manipulator systems for safe use in HRC systems.

### SUMMARY

The objects are achieved with the aid of an end effector protection system and a manipulator system as shown and described herein.

The objects are in particular achieved with the aid of an end effector protection system for at least partially enveloping an end effector of a manipulator, which end effector protection system comprises at least one enveloping structure, which is designed to at least partially envelop the end effector. The enveloping structure is designed to be movable in order to be able to set the degree of envelopment of the end effector, and the end effector protection system further comprises at least one velocity-dependent damping element, which is associated with the enveloping structure and is designed to counteract a movement of the enveloping structure as a function of the velocity.

The term “end effector” includes all tools, objects or devices that can be used by a robot or manipulator for machining a workpiece. Enveloping an end effector generally reduces the accessibility or reachability of the end effector from the outside. For this purpose, the end effector protection system comprises an enveloping structure that is designed to at least partially envelop the end effector in order to reduce the risk of injuries caused, for example, by rapidly rotating, sharp-edged or pointed end effectors.

An end effector can effectively be protected by the use of velocity-dependent damping elements. If, for example, the enveloping structure extends beyond a distal end of the end effector in tool impact direction, an effective mechanical protection for the end effector can be provided. If, for example, during the process, the manipulator collides with an object or with a human in the space, the enveloping structure provides a protection of the end effector, because the end effector is at least partially enveloped by the enveloping structure.

Furthermore, if the collision velocity is above a certain limit velocity, as a result of which the end effector would unintentionally be exposed, the velocity-dependent damping element prevents the enveloping structure from being moved counter to the tool impact direction. The person skilled in the art understands that the velocity-dependent damping element does not necessarily prevent the movement of the enveloping structure completely; rather, due to the damping properties, it can also permit a minimal amount of movement. It is advantageous that the damping element can prevent a sudden exposure of the end effector and can ensure that the end effector is exposed, for example, only during a slow or controlled movement of the enveloping structure. The risk potential arising from a dangerous end effector is thus minimized. If the enveloping structure enveloping the end effector is in fact placed on an object, such as a workpiece, as intended, and the travel velocity is below a limit velocity, the enveloping structure can be moved counter to the tool impact direction and the end effector can be exposed. If, however, a human bumps against the enveloping structure, for example unintentionally, the damping element prevents an immediate exposure of the end effector and injuries can be avoided.

In particular, due to the damping constant of the damping element, the movement of the enveloping structure can take place at substantially the travel velocity of the manipulator. Thus, the manipulator is not or hardly slowed down, and the clock frequency of the manipulator, or the end effector, is not reduced.

Any damping elements that can generate a velocity-dependent counterforce, which counteracts a movement of the enveloping structure counter to the tool impact direction, can be used as damping elements.

The movement of the enveloping structure can be achieved in a variety of ways. The enveloping structure can be mounted in a displaceable manner, for example, thus allowing it to be displaced axially in/counter to the tool impact direction. The enveloping structure can alternatively also be designed to be movable in itself, and only a part of the enveloping structure can be moved. The enveloping structure can in particular be designed to be compressible or deformable in order to be able to set the degree of envelopment of the end effector.

The enveloping structure can in particular be arranged so as to be movable substantially parallel to the tool impact direction A of the end effector. If the enveloping structure is arranged so as to be movable substantially parallel to the tool impact direction A of the end effector, a simple mechanical structure is possible. For example, the enveloping structure can be displaced axially relative to the end effector in order to set the degree of envelopment. The tool impact direction A is typically the positive Z direction of the end effector coordinate system. For a screwing tool, for example, the tool impact direction is the axial direction of the rotating spindle which faces away from the tool tip.

The enveloping structure can in particular comprise at least two protective elements, which are arranged in a uniformly distributed manner around the circumference of the end effector, wherein the protective elements are preferably designed such that they can move independently of one another.

For example, the enveloping structure can comprise two protective elements, which lie across from one another, i.e. are arranged in a circumferentially uniformly distributed manner. If, for example, the enveloping structure comprises three protective elements, these can be spaced circumferentially 120° from one other. A circumferentially uniform distribution allows uniform protection of the end effector from all sides. If the protective elements are designed to be movable independently of one another, the end effector can also be protected when it is used on workpieces with uneven surfaces, for example. If a screw is being screwed onto a convex surface, for example, some protective elements can protrude further in tool impact direction than other protective elements, because they are designed to be movable independently of one another and thus follow the surface of the workpiece. This results in an envelopment of the end effector, even if said end effector is in use, and in effective protection.

The protective elements can in particular be arranged in at least two rows around the end effector, wherein the protective elements of a first row are preferably arranged circumferentially offset with respect to the protective elements of a second row. The protective elements of the first and second rows further preferably partially overlap, in order to provide a circumferentially complete enveloping structure. An arrangement of the protective elements in at least two rows allows the provision of a complete envelopment of the end effector, which prevents the radial accessibility or reachability of the end effector from the outside. At the same time, however, in the respective use, the end effector cannot be hermetically enclosed by the workpiece to be machined and the enveloping structure. This allows the end effector to be actively and/or passively cooled during use and to discharge cooling medium, such as air or other known cooling media, through the rows of the protective elements. In the case of machining a workpiece with the aid of the end effector, for example, a cooling lubricating medium can be discharged. In another application, for example, when welding with the aid of the end effector, a present person can be protected from heat, UV light and/or welding spatter, while allowing sufficient convection to protect the workpiece against overheating.

The at least two protective elements of the enveloping structure can furthermore comprise a rigid main body. A rigid main body can be made of metal or a plastic, for example. Rigid main bodies provide a stable enveloping structure, thus reliably blocking the accessibility of the end effector. A piercing of the enveloping structure, for example, by a tool and/or workpiece guided by a person or another manipulator can be prevented. Safety can thus be increased further.

The end effector protection system can further comprise at least two velocity-dependent damping elements, wherein each velocity-dependent damping element is preferably coupled with at least one protective element of the enveloping structure. If a separate damping element is associated with each of the protective elements, the independent movability can also be realized as a function of the velocity, as described above. Two protective elements can also be associated with one damping element, for example, in order to enable a light and simple structure of the end effector protection system.

The enveloping structure can further comprise a protective sheath to completely radially enclose the end effector along the tool impact direction A. A protective sheath, which completely radially encloses the end effector along the tool impact direction, provides the highest possible level of protection. In order to allow the use of the end effector, the protective sheath is open in tool impact direction. This can be achieved, for example, with a cylindrical or frustoconical protective sheath. Other forms are possible as well. The protective sheath can in particular consist at least partially of a rigid material and/or a flexible material. For example, the protective sheath can comprise a support structure that is covered with a flexible material such as a fabric. The protective sheath can also be made entirely of a rigid material, such as a plastic or a metal, or entirely of a flexible material, such as an elastomer or a textile fabric or a fleece. For example, a flexible protective sheath can be stretched over the protective elements of the enveloping structure.

The enveloping structure and/or the at least two protective elements of the enveloping structure can in particular comprise an elastic extension at their distal end. In particular, when rigid protective elements and/or enveloping structures are used, there is a risk of injury or damage to a person or a workpiece through contact with the distal end of the protective elements and/or the enveloping structure. A flexible end allows gentle placement onto a workpiece without causing damage such as scratches or pressure marks. In particular, for example if the workpiece has an uneven surface, the elastic extension can follow the uneven surface of the workpiece because, due to the pressing force and due to its elastic properties, it adapts to the shape of the surface. This can also improve the protection of a person, because the contact between the protective element or the enveloping structure and the tool is improved and the accessibility of the end effector can be further reduced during the machining process. The flexible extension is preferably made of a silicone, an elastomer or a thermoplastic elastomer.

The flexible extension can in particular be integrally formed with the protective element and/or the enveloping structure. This can be achieved by means of plastic structures with a variable degree of hardness, for example. The flexible extension can furthermore also be a separate extension, which is attached to the protective element and/or the enveloping structure using conventional means.

The enveloping structure can in particular comprise an expandable volume body and the volume of the volume body can be increasable by filling with a medium, in particular with air, in order to be able to set the degree of envelopment of the end effector. The expandable volume body is preferably designed as an inflatable body. In simple embodiments, the enveloping structure corresponds to the volume body, or is identical to said volume body. The volume body can be expanded by being filled with a medium, i.e. the enveloping structure or volume body is designed to be movable. The person skilled in the art understands that the medium can be present in different phases. The medium can thus be air, for example, or also a fluid. It is therefore advantageously possible to vary the dimensions of the volume body, in order to set the degree of envelopment of the tool. The generally preferred medium is air, because air is often already available in production processes or workshops in the form of compressed air, and is also non-toxic, cost-effective and easily accessible.

The enveloping structure of the protection system can in particular be designed such that the degree of envelopment of the tool is greater, the greater the volume of the volume body. The envelopment of the end effector by the enveloping structure is consequently increased by filling the volume body with the medium, so that the accessibility of the end effector is reduced. In this condition, the volume body advantageously encloses the end effector and/or an end effector operating area, even if the manipulator is at rest, and thus protects against possible injuries or damage by the end effector. Emptying the volume body preferably collapses said volume body and exposes the end effector so that it can be used.

In order to be able to discharge the medium, the damping element can in particular comprise a valve. If the damping element comprises a valve, or if the damping element is designed as a valve, the damping element can counteract a movement of the volume body or the enveloping structure in a velocity-dependent manner. If the enveloping structure envelops the end effector, for example, in the manner in which the enveloping structure extends beyond a distal end of the end effector in tool impact direction, and the enveloping structure comes into contact with an object, the collision velocity (i.e. the travel velocity of the manipulator) determines whether and/or how far the enveloping structure is moved counter to the tool impact direction as a result of the contact.

If the collision velocity is below a certain limit velocity, the medium can slowly escape from the volume body and the enveloping structure is moved counter to the tool impact direction to reduce the degree of envelopment of the end effector. If, on the other hand, the collision velocity is above a certain limit velocity, the medium cannot escape quickly enough from the volume body and the enveloping structure is not moved or is hardly moved counter to the tool impact direction. A movement of the enveloping structure can thus be counteracted in a velocity-dependent manner and an effective protection of the end effector can be ensured.

The end effector protection system can further comprise a fastening ring, which is designed to detachably mount the end effector protection system on the manipulator. The fastening ring can comprise two half rings, for example, which can be coupled together to be able to attach the end effector protection system to the manipulator. The attachment is preferably accomplished by means of a clamping connection or a screw connection. The manipulator can also comprise corresponding devices for directly connecting the fastening ring to the manipulator by means of fastening means, such as screws for example. Other fastening systems are possible as well. If the end effector protection system is detachably attached to the manipulator, it can easily be adapted or retrofitted to different end effectors, for example. It is, of course, also possible to attach the end effector protection system to the end effector or the tool itself by means of said fastening ring.

The damping element can in particular be a hydraulic or pneumatic shock absorber. Hydraulic or pneumatic shock absorbers are particularly advantageous, because they are inexpensive to obtain and operate efficiently. Pneumatic and/or hydraulic systems are in particular often available on manipulators or in the production environment, so that the damping elements can easily be coupled to these systems should this be necessary. The hydraulic and/or pneumatic shock absorbers can also be stand-alone shock absorbers that do not have to be connected to a pneumatic and/or hydraulic system.

The end effector protection system can moreover also comprise a spring element, which pushes the enveloping structure with a specific force into a position that corresponds to a maximum degree of envelopment of the end effector. A spring element, which pushes the enveloping structure with a specific force into the position in which a maximum degree of envelopment of the end effector is achieved, prevents the end effector from being exposed or the degree of envelopment from being reduced as a result of weak forces. The end effector can thus be reliably protected.

The end effector protection system can further comprise at least two spring elements, wherein each spring element is preferably coupled with at least one protective element of the enveloping structure. If a separate spring element is associated with each of the protective elements, the independent movability, in particular the pushing back of the protective elements, can be carried out separately in order to provide a best possible envelopment when the end effector is pulled back, for example from an uneven surface. The provision of a plurality of spring elements allows the protective elements to be in contact with a workpiece surface until that specific protective element has reached the maximum degree of envelopment. Two protective elements can also be associated with one spring element, for example, in order to enable a light and simple structure of the end effector protection system.

The spring element can in particular be a pneumatic spring, wherein the damping element is preferably integrally formed with the pneumatic spring. The pneumatic spring can be a gas pressure spring, for example, which is preferably [sic]. Pneumatic springs are characterized by a force which is virtually independent of the spring deflection, and a small space requirement. They also allow the integration of a damping element. Very compact systems can thus be provided.

The spring element can also be a metallic spring, an air spring and/or a plastic spring. Combinations of different spring elements are possible as well.

The objects are further achieved with the aid of a manipulator system comprising a manipulator, an end effector, which is attached to the manipulator and preferably comprises a tool with a rotating spindle, and an end effector protection system, which at least partially envelops the end effector of the manipulator. Due to the end effector protection system, the manipulator system can in particular be used in HRC environments, thus allowing the collaboration between manipulator and human without exposing the human to high risk. Furthermore, since the end effectors are reliably protected, the end effector protection system allows the manipulator to be used without the need to excessively reduce the manipulator velocity.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic representation of an exemplary manipulator system in accordance with the present disclosure;

FIG. 2 is a schematic representation of an exemplary end effector protection system;

FIG. 3A is a schematic representation of a further exemplary end effector protection system;

FIG. 3B depicts an exemplary protective sheath for use in an end effector protection system; and

FIG. 4 is a schematic diagram for explaining the operation of the exemplary end effector protection system.

### DETAILED DESCRIPTION

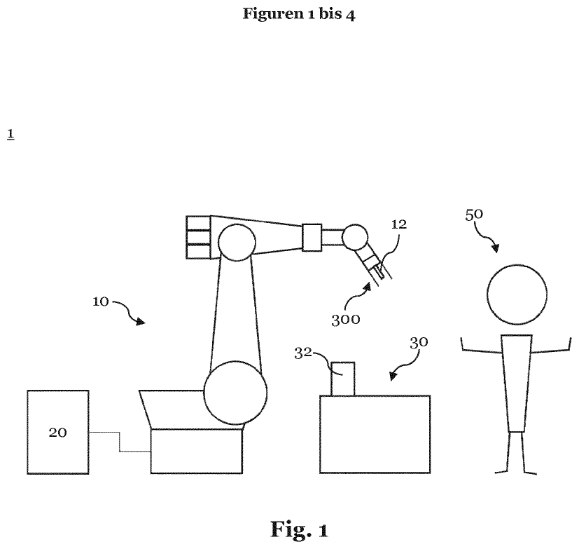

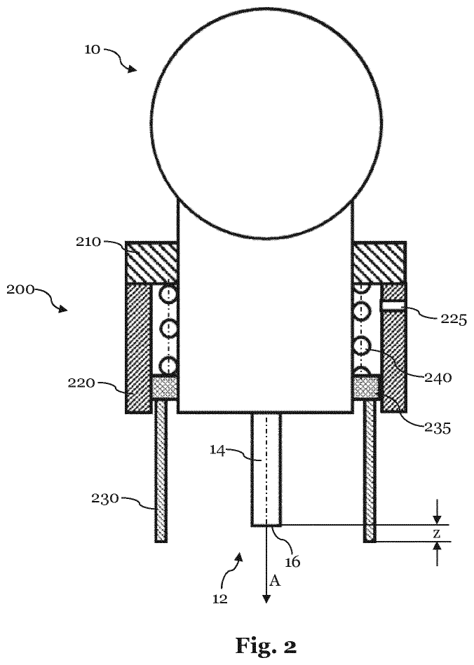

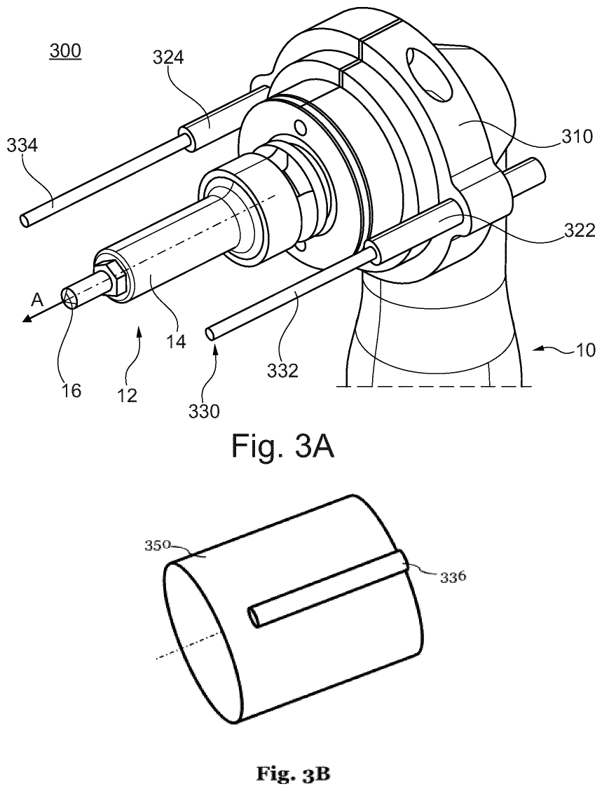

FIG. 1 in particular shows a manipulator system 1 comprising a manipulator 10, which is controlled by a control device 20. The manipulator comprises an end effector 12 which is, for example, a screwing tool. An end effector protection system 300 is attached to the manipulator 10. The end effector protection system 300 comprises an enveloping structure, which is explained in more detail with reference to FIGS. 2, 3A and 3B. The enveloping structure envelops the end effector 12 at least partially. The end effector 12 is thus protected from the environment and the manipulator 10 can be used in HRC systems, so that a human 50 can collaborate with the manipulator 10 in the immediate vicinity of the manipulator 10 without additional safety devices, such as safety fences. The manipulator 10 and the end effector 12 can be designed to manipulate, for example screw together, workpieces 32. The workpieces 32 can be provided on a workpiece supply device 30, such as a conveyor belt.

FIG. 2 shows a similar end effector protection system 200, which can be attached to the manipulator 10. The end effector protection system 200 is in particular attached to the manipulator 10 by means of a fastening ring 210. The manipulator 10 comprises an end effector 12, which is a screwing tool, for example. The end effector 12 comprises a freely rotating spindle 14, which comprises a distal end 16 in tool impact direction A

An enveloping structure 230 extends beyond the distal end 16 of the end effector 12 in tool impact direction A by an amount z. To protect the end effector radially, the enveloping structure 230 is preferably configured as a cylindrical sheath. The enveloping structure 230 is designed to be movable in order to be able to set the degree of envelopment of the end effector. The enveloping structure 230 is in particular designed to be axially displaceable.

To achieve this, the enveloping structure 230 is guided in the damping element 220. The damping element 220 can, for example, be a pneumatic or hydraulic shock absorber. In the event of an impact or a collision of the enveloping structure 230 in tool impact direction A with an object or a person, a fluid or a gas, such as compressed air, which is present in the damping element 220, is fed out through the opening 225 into a reservoir (not depicted). Due to the properties of the fluid and/or gas, the degree of movement of the enveloping structure 230 is a function of the collision velocity.

The force which counteracts the movement of the enveloping structure 230 against the tool impact direction A, in particular, is a function of the collision velocity. The enveloping structure 230 is further coupled with the damping element 220 via a sealing ring 235. The sealing ring 235 is used in the damping element 220 as a piston.

The end effector protection system 200 further comprises a spring element 240, which pushes the enveloping structure 230 with a specific force, the spring force, in the direction of the tool impact direction A.

FIG. 3A shows another end effector protection system 300, which can be attached to a manipulator 10. The end effector protection system 300 is attached to the manipulator 10 by means of a two-part fastening ring 310. The manipulator 10 comprises an end effector 12, a screwing tool for example, which has a rotatable spindle 14 with a distal end 16. The end effector protection system 300 further comprises two protective elements 332, 334, which at least partially envelop the end effector 12 of the manipulator 10 and are arranged in a uniformly distributed manner around the circumference of the end effector 12. The protective elements 332, 334 are respectively coupled with velocity-dependent damping elements 323, 324.

As can be seen in FIG. 3B, the end effector protection system 300 may comprise a protective sheath 350, which can preferably be coupled with the protective elements 332, 334. To achieve this, the protective sheath 350 comprises receptacles 336, which can couple with the protective elements 332, 334. The receptacles 336 can, as shown, be attached to the outside of the protective sheath. The receptacles can also be attached on the inside of the protective sheath. The receptacles can moreover be integrally formed with the protective sheath, for example as a bore in a wall of the protective sheath. The protective sheath can be made of a rigid material and/or of a flexible material.

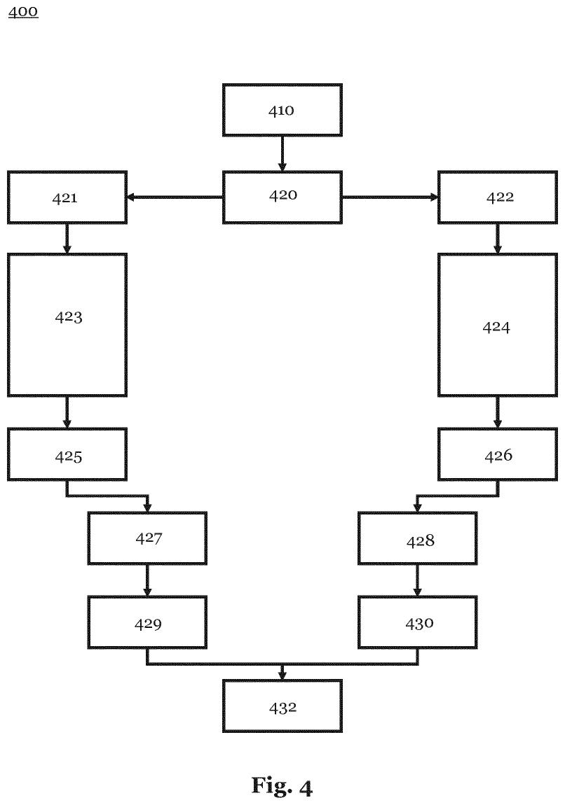

FIG. 4 shows the schematic operation of an end effector protection system 200, 300 in a flow chart. In a first Step 410, the manipulator is moved with a travel velocity until it collides with an object and/or a human in a Step 420. In this Step 420, a control device 20 determines whether the collision occurred in the space or in a predetermined processing position.

If a collision is detected at a predetermined processing position (Step 421) and the collision velocity is less than a limit velocity of the adjustable damping system (Step 423), the enveloping structure can be moved against the tool impact direction A in Step 425, so that the degree of envelopment is reduced and the end effector is partially exposed. The end effector can subsequently be used in Step 427, so that a screw connection, for example, can be created. In Step 429, the manipulator is moved further and the enveloping structure returns to its original position, so that in Step 432 the end effector is protected and the manipulator can be moved at full velocity.

If a collision is detected in the space (Step 422), however, and the travel velocity/the collision velocity of the manipulator is greater than the limit velocity of the velocity-dependent damping element (Step 424), the damping element decelerates the collision in Step 426. In particular, a high damping force is transferred to the enveloping structure. The enveloping structure is thus moved only minimally against the tool impact direction A. In Step 428, a collision can be detected by means of the control device 20 of the manipulator system 1 and appropriate onward travel of the manipulator can be permitted in Step 430. In step 432, the normal operation of the manipulator can be resumed.

As can be seen from the preceding example, the end effector can be used or protected as a function of the collision velocity. An effective protection of any humans present in the vicinity can thus be provided.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Manipulator system
10 Manipulator
12 End effector
14 Spindle
16 Distal end
20 Control device
30 Workpiece supply device
32 Workpiece
50 Human
200, 300 End effector protection system
210, 310 Fastening ring

1-16. (canceled)

17. An end effector protection system for at least partially enveloping an end effector of a robotic manipulator, the end effector protection system comprising:
at least one enveloping structure configured to at least partially envelop the end effector of the robotic manipulator;
wherein the enveloping structure is movable relative to the end effector in order to set a degree of envelopment of the end effector; and
at least one velocity-dependent damping element associated with the enveloping structure and configured to counteract a movement of the enveloping structure as a function of velocity.

18. The end effector protection system of claim 17, wherein the enveloping structure is configured to be movable in a direction substantially parallel to a tool impact direction of the end effector.

19. The end effector protection system of claim 17, wherein the enveloping structure comprises at least two protective elements arranged in a uniformly distributed manner around a circumference of the end effector.

20. The end effector protection system of claim 19, wherein the protective elements are configured for movement independently of one another.

21. The end effector protection system of claim 19, wherein the protective elements are arranged in at least first and second rows around the end effector.

22. The end effector protection system of claim 21, wherein:
the protective elements of the first row are arranged circumferentially offset with respect to the protective elements of the second row; and
the protective elements of the first and second rows at least partially overlap, in order to provide a circumferentially complete enveloping structure.

23. The end effector protection system of claim 19, wherein the at least two protective elements of the enveloping structure comprise a rigid main body.

24. The end effector protection system of claim 19, wherein:
the end effector protection system comprises at least two velocity-dependent damping elements; and
each velocity-dependent damping element is operatively coupled with at least one protective element.

25. The end effector protection system of claim 17, wherein the enveloping structure further comprises a protective sheath configured to completely radially enclose the end effector along a tool impact direction.

26. The end effector protection system of claim 25, wherein the protective sheath is configured as one of a cylindrical sheath or frustoconical sheath.

27. The end effector protection system of claim 17, wherein the enveloping structure is guided in the damping element.

28. The end effector protection system of claim 19, wherein at least one of the enveloping structure or the at least two protective elements of the enveloping structure comprise an elastic extension on distal ends thereof.

29. The end effector protection system of claim 17, wherein the enveloping structure comprises an expandable volume body, wherein the volume of the body is increasable by filling the body with a medium to thereby set a degree of envelopment of the end effector.

30. The end effector protection system of claim 17, further comprising a fastening ring configured to detachably mount the end effector protection system on the manipulator.

31. The end effector protection system of claim 17, wherein the at least one damping element is one of a hydraulic shock absorber or a pneumatic shock absorber.

32. The end effector protection system of claim 17, further comprising a spring element configured to at least one of:
push the enveloping structure with a specific force into a position that corresponds to a maximum degree of envelopment of the end effector; or
push the enveloping structure with a specific force in the direction of a tool impact direction.

33. The end effector protection system of claim 32, wherein:
the enveloping structure comprises at least two protective elements arranged in a uniformly distributed manner around a circumference of the end effector; and
the end effector protection system comprises at least two spring elements, wherein each spring element is coupled with at least one protective element of the enveloping structure.

34. The end effector protection system of claim 32, wherein:
the spring element is a pneumatic spring; and
the at least one damping element is integrally formed with the pneumatic spring.

35. A manipulator system, comprising:
a robotic manipulator;
an end effector attached to the manipulator; and
an end effector protection system according to claim 17 at least partially enveloping the end effector.
